(19) United States
(12) Patent Application Publication
(10) Pub. No.: US 2025/0145848 A1
(43) Pub. Date: May 8, 2025

(54) Polymer Coating For Downhole Tools

(71) Applicant: Halliburton Energy Services, Inc., Houston, TX (US)

(72) Inventors: Somen Kumar Bhudolia, Singapore (SG); Shashwat Shukla, Singapore (SG); Cheng Chau Lum, Singapore (SG); Vishal Vilas Raut, Singapore (SG); Arpana Singh, Singapore (SG)

(73) Assignee: Halliburton Energy Services, Inc., Houston, TX (US)

(21) Appl. No.: 18/674,439

(22) Filed: May 24, 2024

Related U.S. Application Data
(60) Provisional application No. 63/595,644, filed on Nov. 2, 2023.

(51) Int. Cl. C09D 127/18; C08J 7/04; C09D 167/00; E21B 41/00

(52) U.S. Cl. CPC C09D 127/18; C08J 7/0427; C09D 167/00; C08J 2427/18; C08J 2467/00; E21B 41/00

(57) ABSTRACT

Disclosed herein are systems and methods of using a coating solution such as an aromatic copolyester thermoset (ACT) to improve the wear, galling, and corrosion resistances of downhole tools and their sub-components. Aromatic copolyester thermoset may be reinforced with filler material. Further, the aromatic copolyester thermoset reinforced with filler material may be used in a borehole as a composite hollow profile, for example. In some examples, the systems may comprise a substrate for downhole applications coated with an aromatic thermosetting copolyester mixed with polytetrafluoroethylene (PTFE).

### BACKGROUND

Wellbores are commonly drilled to enable the production of subterranean fluids such as hydrocarbons (e.g., oil and gas). A plurality of interconnected tubulars, such as a casing string, may be placed and cemented in a subterranean borehole to protect the structural integrity of the subterranean borehole which thereby forms a wellbore. The casing string may additionally provide a conduit for conveying produced subterranean fluids from one or more subterranean formations (e.g., reservoirs) to a surface location. Wellbore equipment, which may be conveyed in or connected to the wellbore may include one or more devices which either promote or impede the production of subterranean fluids from a subterranean formation to a surface location. For example, pumps may be utilized to convey subterranean fluids to a surface location, while production isolation devices may prevent the production of subterranean fluids.

In some scenarios where wear, galling, and corrosion are important to overcome, coating materials may be useful for downhole tools and earth-boring drill bit. Downhole tools and earth-boring drill bit are mostly constructed with metals and superalloys that can be prone to galling and wear undergoing metal to metal contact. They also undergo severe corrosion in presence of chemicals and gases present in wellbore environment. Many downhole tools like mandrels, tool casings, tubing, pressure housings, valve body, plugs, and others equipment with hollow profiles are metallic while some are non-metallic. Therefore, there may be different requirements of metal to metal or metal to non-metal contacts depending upon the downhole tool applications.

### BRIEF DESCRIPTION OF THE DRAWINGS

These drawings illustrate certain aspects of some of the embodiments of the present disclosure and should not be used to limit or define the method.

FIG. 1 is a schematic diagram of a downhole fluid sampling tool according to embodiments of the present disclosure.

FIG. 2 is a schematic diagram of a downhole fluid sampling tool disposed on a drill string in a drilling operation according to embodiments of the present disclosure.

FIG. 3 is a schematic of the aromatic copolyester thermosetting (ACT) coating process according to embodiments of the present disclosure.

FIG. 4 shows the results of wear test of aromatic thermosetting copolyester (ATSP) coatings according to embodiments of the present disclosure as compared to other coatings on an Inconel 718 substrate as per ASTM G77 standard of testing following the mass loss as a function of the material tested.

FIG. 5 shows the anti-galling testing of aromatic thermosetting copolyester (ATSP) coatings according to embodiments of the present disclosure and other coatings on Inconel 718 following the ASTM G98 standard of testing.

FIG. 6 is a picture of a sample before testing with coated 4140-steel on the left-hand side and coated Inconel 718 alloy on the right-hand side.

FIG. 7 shows a schematic of the galling test set-up following the ASTM G98 standard of testing.

FIG. 8 is a picture of the test coupons before the ASTM G98 standard of testing for the aromatic thermosetting copolyester (ATSP) coating deposited on 4140 steel on the left-hand side and deposited on the Inconel 718 on the right-hand side.

FIG. 9 shows the results of the anti-galling testing of aromatic thermosetting copolyester (ATSP) coatings and other coatings on Inconel 718 following the ASTM G98 standard of testing.

FIG. 10A shows the picture of the anti-galling test result with the upper buttons being 4140 steel coated with the aromatic thermosetting copolyester (ATSP) while the lower target is 4140 steel coated with the aromatic thermosetting copolyester (ATSP).

FIG. 10B shows the picture of the anti-galling test result with the upper buttons being 4140 steel without any coating while the lower target is 4140 steel coated with the aromatic thermosetting copolyester (ATSP).

FIG. 10C shows the picture of the anti-galling test result with the upper buttons being 718 alloy coated with the aromatic thermosetting copolyester (ATSP) while the lower target is 718 alloy coated with the aromatic thermosetting copolyester (ATSP).

FIG. 10D shows the picture of the anti-galling test result with the upper buttons being 718 alloy without any coating while the lower target is 718 alloy coated with the aromatic thermosetting copolyester (ATSP).

FIG. 11A is a picture of a coupon for a 4140-steel coated with the aromatic thermosetting copolyester (ATSP) immersed in a solution containing 15% by weight hydrochloric acid for seven days at a temperature of 350 F.

FIG. 11B is a picture of the coupon for the 4140-steel coated with the aromatic thermosetting copolyester (ATSP) after the immersion test.

### DETAILED DESCRIPTION

Aspects of the disclosure include alternative coatings to existing metallic and non-metallic coatings as some downhole tools undergo adverse downhole conditions. More specifically, disclosed herein are systems and methods of using a coating solution such as an aromatic copolyester thermoset (ACT), for example, to improve the wear, galling, and corrosion resistances of downhole tools and their sub-components. Aromatic copolyester thermoset may be reinforced with filler material. Further, the aromatic copolyester thermoset reinforced with filler material may be used in a borehole as a composite hollow profile, for example.

Aromatic copolyester thermoset, such as aromatic thermosetting copolyester (ATSP) with a glass transition temperature (T_{g}) of about 307° C. available from ATSP Innovations, LLC, headquartered in Houston, Texas, USA, can be labeled as a resin or as a polymer. Aromatic thermosetting copolyester is formed by crosslinking oligomers. Both the oligomers (before crosslinking) and the aromatic thermosetting copolyester (as a thermoset after crosslinking) can have the following structure as a repeat unit of the main chain of the chemical structure:

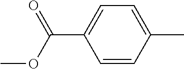

which includes an aromatic ring (benzene ring).

Also, the depicted structure above includes a carbon single bonded to an oxygen, double bonded to another oxygen, and single bonded to a carbon of the aromatic ring. Thus, the aromatic thermosetting copolyester (e.g., ATSP) includes an aromatic polyester backbone. The oligomers and the aromatic thermosetting copolyester may be carboxylic acid-capped (capped with a carboxylic acid functional group as the end group) or acetoxy-capped (capped with an acetoxy functional group as the end group). The crosslinked network of the aromatic thermosetting copolyester morphology may be composed of an aromatic polyester backbone interconnected via covalent single/double oxygen bonds. At least a portion of the aromatic thermosetting copolyester (e.g., ATSP) matrix is generally amorphous.

Aromatic thermosetting copolyester (ATSP) coating is self-healing and highly resistant to wear, galling, and chemicals, and can be used in multitude of downhole applications to counter the existing challenges of wear, galling, and corrosion. The aromatic thermosetting copolyester can be used as a coating material for downhole components such as plugs, mandrels, tubing, casings, packers, valves such as safety valves and barrier valves, seal assemblies, drill bits, for example. It can be used on any downhole tool components or their subcomponents having metal to metal contact or metal to non-metal contact surfaces requiring anti galling and/or anti wear characteristics. To achieve high performance and durable contacts, it is necessary to have low friction, low wear, and low vibration between different contact surfaces. Further, the aromatic thermosetting copolyester has excellent corrosion resistance against highly concentrated acids and gases which are present in downhole environment in drilling, production, and stimulation treatments such as hydraulic fracturing, matrix acidizing, and enhanced oil recovery, for example.

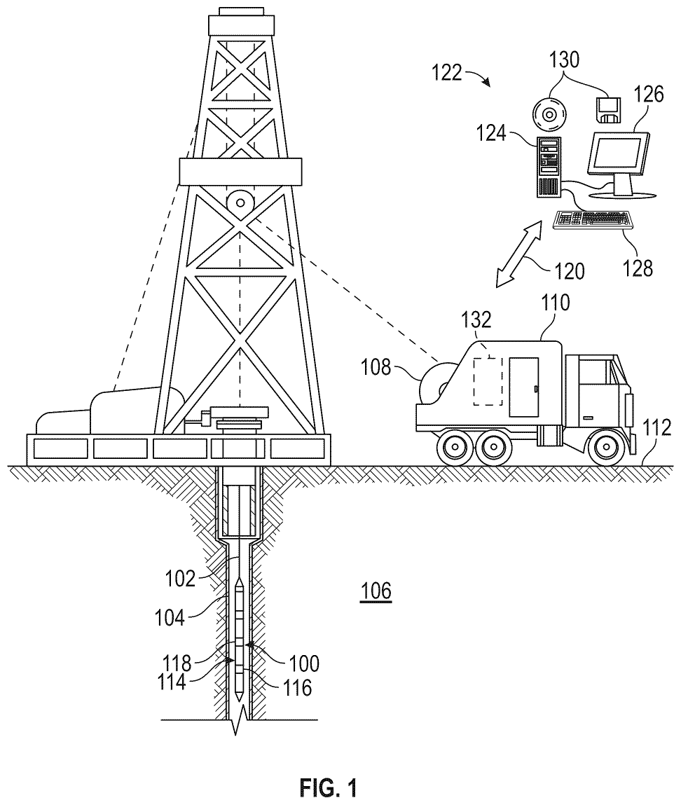

Aromatic thermosetting copolyester (ATSP) can be deposited on any downhole tools, such as a downhole fluid sampling tool and its subcomponents and/or any drill string. FIG. 1 is a schematic diagram of downhole fluid sampling tool 100 on a conveyance 102. As illustrated, wellbore 104 may extend through subterranean formation 106. In examples, reservoir fluid may be contaminated with well fluid (e.g., drilling fluid) from wellbore 104. As described herein, the fluid sample may be analyzed to determine fluid contamination and other fluid properties of the reservoir fluid. As illustrated, a wellbore 104 may extend through subterranean formation 106. While the wellbore 104 is shown extending generally vertically into the subterranean formation 106, the principles described herein are also applicable to wellbores that extend at an angle through the subterranean formation 106, such as horizontal and slanted wellbores. For example, although FIG. 1 shows a vertical or low inclination angle well, high inclination angle or horizontal placement of the well and equipment is also possible. It should further be noted that while FIG. 1 generally depicts a land-based operation, those skilled in the art will readily recognize that the principles described herein are equally applicable to subsea operations that employ floating or sea-based platforms and rigs, without departing from the scope of the disclosure.

As illustrated, a hoist 108 may be used to run downhole fluid sampling tool 100 into wellbore 104. Hoist 108 may be disposed on vehicle 110 and controlled in control room 132. Hoist 108 may be used, for example, to raise and lower conveyance 102 in wellbore 104. While hoist 108 is shown on vehicle 110, it should be understood that conveyance 102 may alternatively be disposed from a hoist 108 that is installed at surface 112 instead of being located on vehicle 110. Downhole fluid sampling tool 100 may be suspended in wellbore 104 on conveyance 102. Other conveyance types may be used for conveying downhole fluid sampling tool 100 into wellbore 104, including coiled tubing and wired drill pipe, for example. Downhole fluid sampling tool 100 may comprise a tool body 114, which may be elongated as shown on FIG. 1. Tool body 114 may be any suitable material, including without limitation titanium, stainless steel, alloys, plastic, combinations thereof, and the like. Downhole fluid sampling tool 100 may further comprise one or more sensors 116 for measuring properties of the fluid sample, reservoir fluid, wellbore 104, subterranean formation 106, or the like. In examples, downhole fluid sampling tool 100 may also comprise a fluid analysis module 118, which may be operable to process information regarding fluid sample, as described below. The downhole fluid sampling tool 100 may be used to collect fluid samples from subterranean formation 106 and may obtain and separately store different fluid samples from subterranean formation 106.

In examples, fluid analysis module 118 may comprise at least one sensor that may continuously monitor a fluid such as a reservoir fluid, formation fluid, wellbore fluid, or formation nonnative fluids such as drilling fluid filtrate. Such monitoring may take place in a fluid flow line or a formation tester probe such as a pad or packer or may be able to make measurements investigating the formation including measurements into the formation. Such sensors comprise optical sensors, acoustic sensors, electromagnetic sensors, conductivity sensors, resistivity sensors, selective electrodes, density sensors, mass sensors, thermal sensors, chromatography sensors, viscosity sensors, bubble point sensors, fluid compressibility sensors, flow rate sensors, pressure sensors, nuclear magnetic resonance (NMR) sensors. Sensors may measure a contrast between drilling fluid filtrate properties and formation fluid properties. Fluid analysis module 118 may be operable to derive properties and characterize the fluid sample. By way of example, fluid analysis module 118 may measure absorption, transmittance, or reflectance spectra and translate such measurements into component concentrations of the fluid sample, which may be lumped component concentrations, as described above. The fluid analysis module 118 may also measure gas-to-oil ratio, fluid composition, water cut, live fluid density, live fluid viscosity, formation pressure, and formation temperature and fluid composition. Fluid analysis module 118 may also be operable to determine fluid contamination of the fluid sample and may comprise any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, or other purposes. The absorption, transmittance, or reflectance spectra absorption, transmittance, or reflectance spectra may be measured with sensors 116 by way of standard operations. For example, fluid analysis module 118 may comprise random access memory (RAM), one or more processing units, such as a central processing unit (CPU), or hardware or software control logic, ROM, and/or other types of nonvolatile memory. Fluid analysis module 118 and fluid sampling tool 100 may be communicatively coupled via communication link 120 with information handling system 122.

Any suitable technique may be used for transmitting signals from the downhole fluid sampling tool 100 to the surface 112. As illustrated, a communication link 120 (which may be wired or wireless, for example) may be provided that may transmit data from downhole fluid sampling tool 100 to an information handling system 122 at surface 112. Information handling system 122 may comprise a processing unit 124, a monitor 126, an input device 128 (e.g., keyboard, mouse, etc.), and/or computer media 130 (e.g., optical disks, magnetic disks) that can store code representative of the methods described herein. Information handling system 122 may act as a data acquisition system and possibly a data processing system that analyzes information from downhole fluid sampling tool 100. For example, information handling system 122 may process the information from downhole fluid sampling tool 100 for determination of fluid contamination. The information handling system 122 may also determine additional properties of the fluid sample (or reservoir fluid), such as component concentrations, pressure-volume-temperature properties (e.g., bubble point, phase envelop prediction, etc.) based on the fluid characterization. This processing may occur at surface 112 in real-time. Alternatively, the processing may occur downhole or at surface 112 or another location after recovery of downhole fluid sampling tool 100 from wellbore 104. Alternatively, the processing may be performed by an information handling system in wellbore 104, such as fluid analysis module 118. The resultant fluid contamination and fluid properties may then be transmitted to surface 112, for example, in real-time.

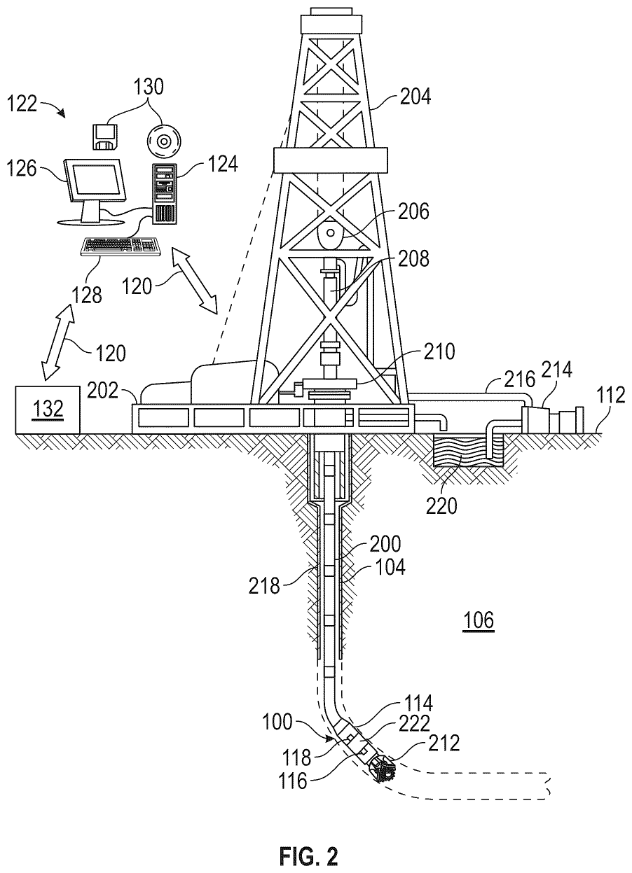

FIG. 2 is a schematic diagram of downhole fluid sampling tool 100 disposed on a drill string 200 in a drilling operation. Downhole fluid sampling tool 100 may be used to obtain a fluid sample, for example, a fluid sample of a reservoir fluid from subterranean formation 106. The reservoir fluid may be contaminated with well fluid (e.g., drilling fluid) from wellbore 104. As described herein, the fluid sample may be analyzed to determine fluid contamination and other fluid properties of the reservoir fluid. As illustrated, a wellbore 104 may extend through subterranean formation 106. While the wellbore 104 is shown extending generally vertically into the subterranean formation 106, the principles described herein are also applicable to wellbores that extend at an angle through the subterranean formation 106, such as horizontal and slanted wellbores. For example, although FIG. 2 shows a vertical or low inclination angle well, high inclination angle or horizontal placement of the well and equipment is also possible. It should further be noted that while FIG. 2 generally depicts a land-based operation, those skilled in the art will readily recognize that the principles described herein are equally applicable to subsea operations that employ floating or sea-based platforms and rigs, without departing from the scope of the disclosure.

As illustrated in FIG. 2, a drilling platform 202 may support a derrick 204 having a traveling block 206 for raising and lowering drill string 200. Drill string 200 may comprise, but is not limited to, drill pipe and coiled tubing, as generally known to those skilled in the art. A kelly 208 may support drill string 200 as it may be lowered through a rotary table 210. A drill bit 212 may be attached to the distal end of drill string 200 and may be driven either by a downhole motor and/or via rotation of drill string 200 from the surface 112. Without limitation, drill bit 212 may comprise roller cone bits, PDC bits, natural diamond bits, any hole openers, reamers, coring bits, and the like. As drill bit 212 rotates, it may create and extend wellbore 104 that penetrates various subterranean formations 106. A pump 214 may circulate drilling fluid through a feed pipe 216 to kelly 208, downhole through interior of drill string 200, through orifices in drill bit 212, back to surface 112 via annulus 218 surrounding drill string 200, and into a retention pit 220.

Drill bit 212 may be just one piece of a downhole assembly that may comprise one or more drill collars 222 and downhole fluid sampling tool 100. Downhole fluid sampling tool 100, which may be built into drill collars 222 may gather measurements and fluid samples as described herein. One or more of the drill collars 222 may form a tool body 114, which may be elongated as shown on FIG. 2. Tool body 114 may be any suitable material, including without limitation titanium, stainless steel, alloys, plastic, combinations thereof, and the like. Downhole fluid sampling tool 100 may be similar in configuration and operation to downhole fluid sampling tool 100 shown on FIG. 1 except that FIG. 2 shows downhole fluid sampling tool 100 disposed on drill string 200. Alternatively, the sampling tool may be lowered into the wellbore after drilling operations on a wireline.

Downhole fluid sampling tool 100 may further comprise one or more sensors 116 for measuring properties of the fluid sample reservoir fluid, wellbore 104, subterranean formation 106, or the like. The one or more sensors 116 may be disposed within fluid analysis module 118. In examples, more than one fluid analysis module may be disposed on drill string 200. The properties of the fluid are measured as the fluid passes from the formation through the tool and into either the wellbore or a sample container. As fluid is flushed in the near wellbore region by the mechanical pump, the fluid that passes through the tool generally reduces in drilling fluid filtrate content, and generally increases in formation fluid content. The downhole fluid sampling tool 100 may be used to collect a fluid sample from subterranean formation 106 when the drilling fluid filtrate content has been determined to be sufficiently low. Sufficiently low depends on the purpose of sampling. For some laboratory testing, below 10% drilling fluid contamination is sufficiently low, while for other laboratory testing, below 1% drilling fluid filtrate contamination is sufficiently low. Sufficiently low also depends on the nature of the formation fluid such that lower requirements are generally needed, the lighter the oil as designated with either a higher GOR or a higher API gravity. Sufficiently low also depends on the rate of cleanup in a cost benefit analysis since longer pump out times required to incrementally reduce the contamination levels may have prohibitively large costs. As previously described, the fluid sample may comprise a reservoir fluid, which may be contaminated with a drilling fluid or drilling fluid filtrate. Downhole fluid sampling tool 100 may obtain and separately store different fluid samples from subterranean formation 106 with fluid analysis module 118. Fluid analysis module 118 may operate and function in the same manner as described above. However, storing of the fluid samples in the downhole fluid sampling tool 100 may be based on the determination of the fluid contamination. For example, if the fluid contamination exceeds a tolerance, then the fluid sample may not be stored. If the fluid contamination is within a tolerance, then the fluid sample may be stored in the downhole fluid sampling tool 100. In examples, contamination may be defined within fluid analysis module 118.

As previously described, information from downhole fluid sampling tool 100 may be transmitted to an information handling system 122, which may be located at surface 112. As illustrated, communication link 120 (which may be wired or wireless, for example) may be provided that may transmit data from downhole fluid sampling tool 100 to an information handling system 122 at surface 112. Information handling system 122 may comprise a processing unit 124, a monitor 126, an input device 128 (e.g., keyboard, mouse, etc.), and/or computer media 130 (e.g., optical disks, magnetic disks) that may store code representative of the methods described herein. In addition to, or in place of processing at surface 112, processing may occur downhole (e.g., fluid analysis module 118). In examples, information handling system 122 may perform computations to estimate asphaltenes within a fluid sample.

Aromatic thermosetting copolyester (ATSP) can be coated on any substrate using any method of deposition including solvent borne coating, powder coating, Chemical Vapor Deposition (CVD), Physical Vapor Deposition (PVD), Electrostatic Spray or Thermal Spray or Cold Spray Deposition, for example. In embodiments, aromatic thermosetting copolyester (ATSP) is coated using Electrostatic Spray or Cold Spray Deposition.

Aromatic thermosetting copolyester can be deposited in any thickness including 1 mm or below, 500 μm or below, 250 μm or below, 100 μm or below, 50 μm or below, 25 μm or below, 10 μm or below, 5 μm or below, or 1 μm or below, 0.5 μm or below, or 0.1 μm or below, or 0.05 μm or below, or 0.01 μm or below. Aromatic thermosetting copolyester can be deposited in any surface roughness including a Root Mean Square (RMS) of 25 μm or below, 10 μm or below, 5 μm or below, or 1 μm or below, 0.5 μm or below, or 0.1 μm or below, or 0.05 μm or below, or 0.01 μm or below, or 0.005 μm or below, 0.001 μm or below.

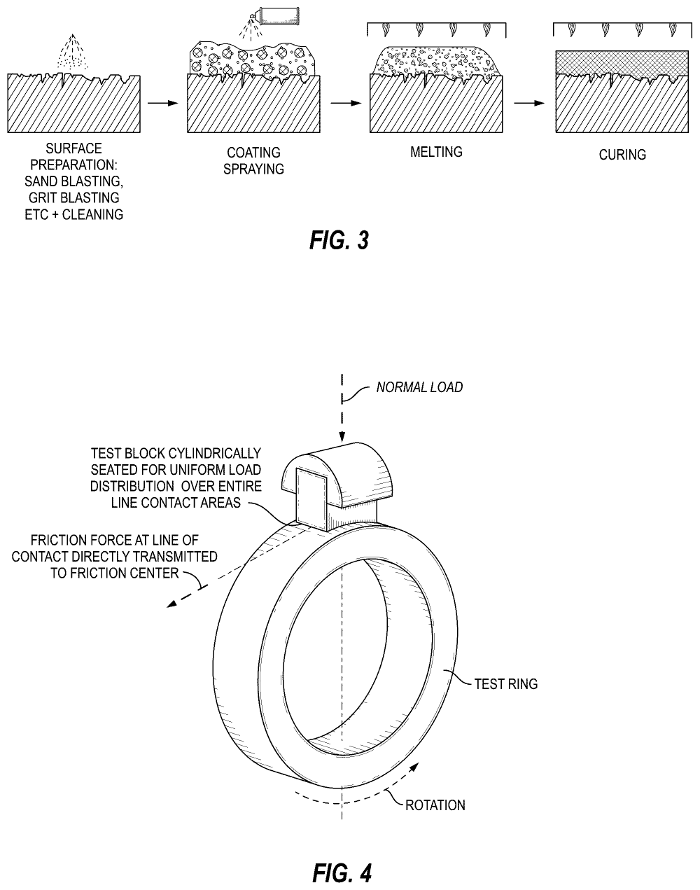

Schematic of the aromatic thermosetting copolyester (ATSP) coating process is shown in FIG. 3. Aromatic thermosetting copolyester oligomers typically solvates in polar aromatic solvents if the solvents borne deposition route is chosen. If the powder coating route is chosen, oligomers are in solid state at room temperature and can be produced in micro-scale powders which are amenable via hot melt processes, slurry, or powder coating, for example. Surface treatment processes such as plasma treatment, grit and sand blasting, or laser treatment can be used for optimal surface preparation, for example. In embodiments, the surface is treated by grit and sand blasting. Ultrasonic cleaning may be performed afterwards. The aromatic thermosetting copolyester coating can be cured using methods such as convection heater, ultrasonic heater, induction heater, infrared heater, eddy current heater, and laser.

Aromatic thermosetting copolyester can be coated on any substrate including metallic and non-metallic substrates. Metallic substrates include various steel grades, stainless steel grades, Ni-based superalloys, high-strength low-alloy steels, martensitic stainless steels, supermartensitic stainless steels, duplex and super duplex stainless steels, austenitic stainless steels, alloys in the Ni—Cr—Mo family, solution-strengthened nickel-based alloys and precipitation-hardening nickel-based alloys, for example. Non-metallic substrates and their composites include polymers such as polyether ether ketone (PEEK), polyetherimide (PEI), polyether ketone ketone (PEKK), polyphenylene sulfide (PPS), polytetrafluoroethylene (PTFE), polyamide (PA), or thermosetting resins such as epoxy, phenolic, bis-maleimide (BMI), for example. The substrate can be any substrate used in the oil and gas industry including any downhole equipment, downhole tools, their components, and subcomponents. The aromatic thermosetting copolyester can be coated using a more economical route such as solvent borne coating or powder coating as compared with other methods like Chemical Vapor Deposition (CVD), Physical Vapor Deposition (PVD), Thermal Spray and Cold Spray Coatings.

FIG. 3 is a schematic of the aromatic copolyester thermosetting (ACT) coating process according to embodiments of the present disclosure. First, the surface is prepared by grit and sand blasting. Then, ultrasonic cleaning is performed. The substrate is then coated with the aromatic copolyester thermosetting (ACT) by spray or electrostatic deposition. The temperature of the substrate coated with the aromatic copolyester thermosetting (ACT) is then raised to 220-240° C. for about 10 minutes to about 60 minutes, or from about 20 minutes to about 50 minutes, or from about 30 minutes to about 40 minutes. Finally, curing occurs at 270° C. for about 1 hour.

Aromatic thermosetting copolyester coating can be used as an alternative solution to existing metallic and non-metallic coatings for wear and galling improvement. Aromatic thermosetting copolyester coating can be used alone as a pristine coating or in combination with some fillers or additives such as polytetrafluoroethylene (PTFE), polyimide, graphite, mullite or MoS2 powders, diamond, boron, copper, carbon, or graphene nanotubes, for example, to selectively improve some properties to meet downhole requirements. Hardening and/or wear additives can be used for a variety of purposes depending upon the targeted applications. These additives are required to improve properties such as hardness, flexibility, adhesion, or resistance to extreme temperatures, for example. PTFE may be used to reduce friction on the aromatic thermosetting copolyester ATSP coating itself as lubricating additive, for example. Additives such as PTFE may be used with ATSP in concentrations from about 0.1 wt % to about 30 wt %. For example, the ATSP-based coating may comprise from about 0.1 wt % to about 30 wt %, from about 0.1 wt % to about 10 wt %, or from about 3 wt % to about 10 wt % for wear and anti-galling performance. For example, the ATSP-based coating may comprise from about 0.1 wt % to about 30 wt %, from about 0.1 wt % to about 10 wt %, from about 0.1 wt % to about 3 wt %, or from about 1 wt % to about 3 wt % for chemical and/or corrosion resistance.

Some commercially available aromatic thermosetting copolyester (ATSP) coating (NOWE grade) from ATSP Innovations or similar may be used successfully for metallic or non-metallic components for downhole tools. Further, different lubricating or hardening additives including polytetrafluoroethylene (PTFE), polyimide (PI), graphite, mullite or MoS2 powders, diamond, boron, copper, carbon, and graphene nanotubes, for example, and hardening and wear additives, can be used for a variety of purposes depending upon the target applications. These additives may be required to improve properties such as hardness, flexibility, adhesion, or resistance to extreme temperatures. As a lubricating additive, polytetrafluoroethylene (PTFE) may be used to reduce friction on the aromatic thermosetting copolyester coating, for example. Metallic substrates intended to be coated with aromatic thermosetting copolyester or modified aromatic thermosetting copolyester can be high-strength low-alloy steels, martensitic stainless steels, supermartensitic stainless steels, duplex and super duplex stainless steels, austenitic stainless steels, alloys in the Ni—Cr—Mo family, solution-strengthened nickel-based alloys and precipitation-hardening nickel-based alloys, for example. Non-metallic substrates and their composites include polymers such as polyether ether ketone (PEEK), polyetherimide (PEI), polyether ketone ketone (PEKK), polyphenylene sulfide (PPS), polytetrafluoroethylene (PTFE), polyamide (PA), polyphthalamide (PPA) or thermosetting resins such as epoxy, phenolic, bis-maleimide (BMI), for example. Further, elastomers may be coated with aromatic thermosetting copolyester for various downhole applications. Aromatic thermosetting copolyester may also be used to coat polymer composites such as epoxy, phenolic, vinyl ester, BMI, PEEK, PEKK, ATSP or other thermosetting vitrimer. Aromatic thermosetting copolyester may be used as a filler on harder coatings such as electroless nickel as replacement for non-metallic fillers (PTFE or PEEK, for instance).

While the aromatic thermosetting copolyester coating may be used for wear, anti-galling, and corrosion resistance, aromatic thermosetting copolyester coating may also be used for harsh downhole chemical environments such as high temperatures, high pressures, and high concentration of hydrogen sulfide (H₂S), high concentration of hydrogen (H₂), high concentration of carbon dioxide (CO₂), or any combinations thereof. Further, the aromatic thermosetting copolyester coating may be used for CO₂ capture and storage applications as the coating will not swell in such conditions. Some downhole tool components like mandrels, casings, and flow tubes undergo severe corrosion in downhole environment including high-temperature, high pressure, chemicals, and gases. Downhole tools coated with aromatic thermosetting copolyester have the ability to withstand elevated temperatures including continuous service temperatures of at least 300° C.

Further, this coating may be used as a self-healing coating for applications where the tools undergo wear and abrasion. Self-healing may be triggered by temperature, pressure, one or more chemicals, or any combination thereof.

Formation of organic and inorganic scales is very dominant in oil and gas producing wells. These scales, such as, asphaltenes, carbonates and sulphates act as an unwanted layer on downhole tools such as casings, valves, production tubes, lift mandrel, for example, and consequently limits the desired production. Aromatic thermosetting copolyester (ATSP) coating or modified ATSP coating may also be used as a barrier layer to separate the more vulnerable metal from aggressive fluids such as brine containing scales and thereby reduce the scaling of the downhole components.

Another embodiment is an apparatus including a first tubular and a second tubular both for downhole applications in a borehole. The first tubular includes a coating comprising a first aromatic thermosetting copolyester. The second tubular is a metallic tubular coupled (bonded, joined) to the first tubular via a coating of a second aromatic thermosetting copolyester on the second tubular. The coating may be applied on a joint tongue of the second tubular.

Finally, conventional non-metallic composites with thermosetting epoxies are operational at typical downhole temperatures but are thermally stable only up to 120° C. for long-term usage. Even high-temperature polymeric systems (e.g., polyimides, bismaleimides, and phenyl-based epoxies) including high-performance thermoplastics [e.g., polyether ether ketone (PEEK) and polyether ketone ketone (PEKK)] have a glass transition temperature of less than 150° C. An increase in the operating envelope (e.g., increased temperature) for polymers that can be utilized for composites in downhole oil-and-gas applications can be beneficial. Embodiments herein disclose aromatic thermosetting copolyester having a glass transition temperature (T_{g}) up to 307° C., which can be utilized as a solution for high-temperature well conditions. The glass transition temperature (T_{g}) of aromatic copolyester thermoset can be in the ranges of 150° C. to 307° C., 170° C. to 307° C., 239° C. to 307° C., 253° C. to 307° C., and 267° C. to 307° C. This aromatic thermosetting copolyester coating may be beneficial for tubulars and different metallic and non-metallic well completion tools including tool mandrels, tool casings, tubing, pressure housings, valve bodies, plugs, and others.

Accordingly, the present disclosure may provide compositions and methods of coating existing metallic and non-metallic coatings to protect substrates against wear and galling. The composition and methods may include any of the various features disclosed herein, including one or more of the following statements.

Statement 1. A system comprising a substrate for downhole applications coated with an aromatic thermosetting copolyester mixed with polytetrafluoroethylene (PTFE).

Statement 2. The system of Statement 1, wherein the coating comprises from about 0.1 wt % to about 30 wt % of PTFE.

Statement 3. The system of Statement 1 or Statement 2, wherein the coating comprises from about 0.1 wt % to 10 wt % PTFE.

Statement 4. The system of any one of Statements 1-3, wherein the coating comprises from about 0.1 wt % to 3 wt % PTFE.

Statement 5. The system of any one of Statements 1-4, wherein the coating thickness is in between about 50 μm and 200 μm.

Statement 6. The system of any one of Statements 1-5, wherein the coating roughness is less than about 8 μm.

Statement 7. The system of any one of Statements 1-6, wherein the coating roughness is less than about 5 μm.

Statement 8. The system of any one of Statements 1-7, wherein the substrate is metallic.

Statement 9. The system of any one of Statements 1-8, wherein the substrate is non-metallic.

Statement 10. The system of any one of Statements 1-9, wherein the coating further comprises at least one additive selected from the group of additives consisting of polyimide (PI), graphite, mullite, molybdenum disulfide (MoS2), diamond, boron, copper, carbon, carbon black, graphene nanotubes, mica, carbon nanotubes (CNTs), polyether ether ketone (PEEK), polyether ketone ketone (PEKK), polyphthalamide (PPA), and any combination thereof.

Statement 11. The system of any one of Statements 1-10, wherein the substrate is a metallic substrate selected from the group of metallic substrates consisting of high-strength low-alloy steels, martensitic stainless steels, supermartensitic stainless steels, duplex stainless steels, super duplex stainless steels, austenitic stainless steels, alloys in the nickel-chromium-molybdenum (Ni—Cr—Mo) family, solution-strengthened nickel-based alloys, precipitation-hardening nickel-based alloys, magnesium-based alloys, and any combination thereof.

Statement 12. The system of any one of Statements 1-10, wherein the substrate is a non-metallic substrate selected from the group of non-metallic substrates consisting of polyether ether ketone (PEEK), polyether ketone ketone (PEKK), polyphthalamide (PPA), polyetherimide (PEI), polyphenylene sulfide (PPS), polytetrafluoroethylene (PTFE), polyamide (PA), epoxy, phenolic, bis-maleimide (BMI), elastomers, and any combination thereof.

Statement 13. The system of any one of Statements 1-10, wherein the substrate for downhole applications comprises at least one substrate selected from the group consisting of sub surface safety valves, barrier valves, mandrels, flow tubes, sleeves, threads, splined cylinders, drill bits, components of sand control screen assembly, seal assemblies, and any combination thereof.

Statement 14. A system comprising a substrate for downhole applications coated with an aromatic thermosetting copolyester mixed with from about 0.1 wt % to about 10 wt % polytetrafluoroethylene (PTFE), wherein the substrate for downhole applications comprises at least one substrate selected from the group consisting of sub surface safety valves, barrier valves, mandrels, flow tubes, sleeves, threads, splined cylinders, drill bits, components of sand control screen assembly, seal assemblies, and any combination thereof.

Statement 15. The system of Statement 14, wherein the coating further comprises at least one additive selected from the group of additives consisting of polyimide (PI), graphite, mullite, MoS2, diamond, boron, copper, carbon, carbon black, graphene nanotubes, mica, carbon nanotubes (CNTs), polyether ether ketone (PEEK), polyether ketone ketone (PEKK), polyphthalamide (PPA), and any combination thereof.

Statement 16. The system of Statement 14 or Statement 15, wherein the coating thickness is in between about 50 μm and 200 μm.

Statement 17. The system of any one of Statements 14-16, wherein the coating roughness is less than about 5 μm.

Statement 18. A system comprising a substrate for downhole applications coated with an aromatic thermosetting copolyester mixed with from about 0.1 wt % to about 10 wt % polytetrafluoroethylene (PTFE), wherein the substrate is a metallic substrate selected from the group of metallic substrates consisting of high-strength low-alloy steels, martensitic stainless steels, supermartensitic stainless steels, duplex stainless steels, super duplex stainless steels, austenitic stainless steels, alloys in the nickel-chromium-molybdenum (Ni—Cr—Mo) family, solution-strengthened nickel-based alloys, precipitation-hardening nickel-based alloys, magnesium-based alloys, and any combination thereof.

Statement 19. The system of Statement 18, wherein the coating further comprises at least one additive selected from the group of additives consisting of polyimide (PI), graphite, mullite, MoS2, diamond, boron, copper, carbon, carbon black, graphene nanotubes, mica, carbon nanotubes (CNTs), polyether ether ketone (PEEK), polyether ketone ketone (PEKK), polyphthalamide (PPA), and any combination thereof.

Statement 20. The system of Statement 18 or Statement 19, wherein the coating thickness is in between about 50 μm and 200 μm.

To facilitate a better understanding of the present invention, the following examples of certain aspects of some embodiments are given. In no way should the following examples be read to limit, or define, the entire scope of the disclosure.

### Examples

Experiments were performed on four different samples. The first sample is an aromatic thermosetting copolyester (ATSP) deposited on a 4140-steel ring and deposited on a 4140-steel block. The 4140-steel substrate is prepared by grit blasting and ultrasonic cleaning. The aromatic thermosetting copolyester (ATSP) coating was then deposited by electrostatic deposition. The coated sample was then cured in a conventional oven at 270° C. for one hour. The coating thickness was measured at around 50±5 μm. This first sample is compared to a second sample which is a 4140-steel plain ring, without any coating, with a 4140-steel block coated with the aromatic thermosetting copolyester (ATSP).

The third sample is an aromatic thermosetting copolyester (ATSP) deposited on an Inconel 718 alloy ring and deposited on an Inconel 718 alloy block. The Inconel 718 alloy substrate is prepared by grit blasting and ultrasonic cleaning. The aromatic thermosetting copolyester (ATSP) coating was then deposited by electrostatic deposition. The coated sample was then cured in a conventional oven at 270° C. for one hour. The coating thickness was measured at around 50±5 μm. This third sample was compared to a fourth sample made up of an Inconel 718 alloy plain ring, without any coating, with a coated Inconel 718 alloy block.

FIG. 4 shows a schematic of the wear test set-up as per ASTM G77 standard of testing following the mass loss as a function of the material tested. Testing was carried out following the Block on Ring Testing (ASTM G77). A normal load is applied to the sample under test while the test ring is rotated. The maximum contact stress of the block on the ring was calculated to reach the minimum yield strength of the base materials. The peak load used during the test was 480 lb, which translates to a maximum Hertzian contact stress of 121.48 Kpsi, a Poission's ratio of 0.29, an elastic modulus of 210 Gpa, and a line contact length of 6.35 mm. The load increment was done at 30 lb in each step; 200 cycles in each load step and 3 minutes at the peak load. There was no galling observed in any test conditions.

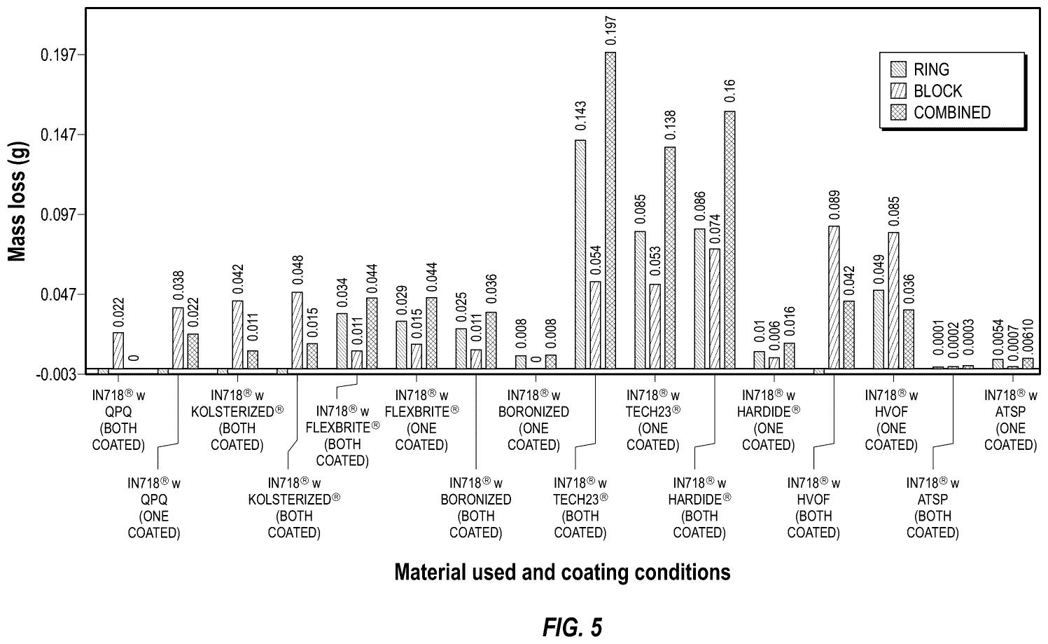

FIG. 5 shows the results of the wear test of aromatic thermosetting copolyester (ATSP) coatings as compared to other coatings on an Inconel 718 substrate as per ASTM G77 standard of testing following the mass loss as a function of the material tested. Testing was carried out following the Block on Ring Testing (ASTM G77) with 200 cycles per load and 3 minutes at 480 lb load. The Inconel 718 substrates coated with aromatic thermosetting copolyester (ATSP) shows excellent results as compared with currently used hard coatings such as QPQ, Kolsterized coating, Flexbrite coating, Boronized coating, Tech23 coating, Hardide coating, HVOF coating, for example. The Inconel 718 substrates coated with aromatic thermosetting copolyester (ATSP) shows a contact stress similar to the yield strength of Inconel 718 alone. Further, the total mass loss for ATSP coated Inconel 718 Ring and ATSP coated Inconel 718 Block is 0.0002 g and 0.0001 g for block and ring, respectively. While for Non-Coated Inconel 718 Ring and coated Inconel 718 block, the total mass loss is 0.0007 g and 0.0054 g for block and ring, respectively. Similarly, the total mass loss for coated 4140 Ring and coated 4140 Block is 0.0005 g and 0.0046 g for block and ring, respectively. While for Non-Coated 4140 Ring and coated 4140 Block, the total mass loss is 0.0002 g and 0.0001 g for block and ring, respectively. These results are excellent with a 50-micronmeters thick aromatic thermosetting copolyester coating on the above-mentioned metallic substrates. Comparing the results of aromatic thermosetting copolyester coating with the hardide coating, which is a nanocrystalline tungsten carbide without any cobalt binder, there are at least ten times less wear for aromatic thermosetting copolyester coating compared to their counterparts without any coating.

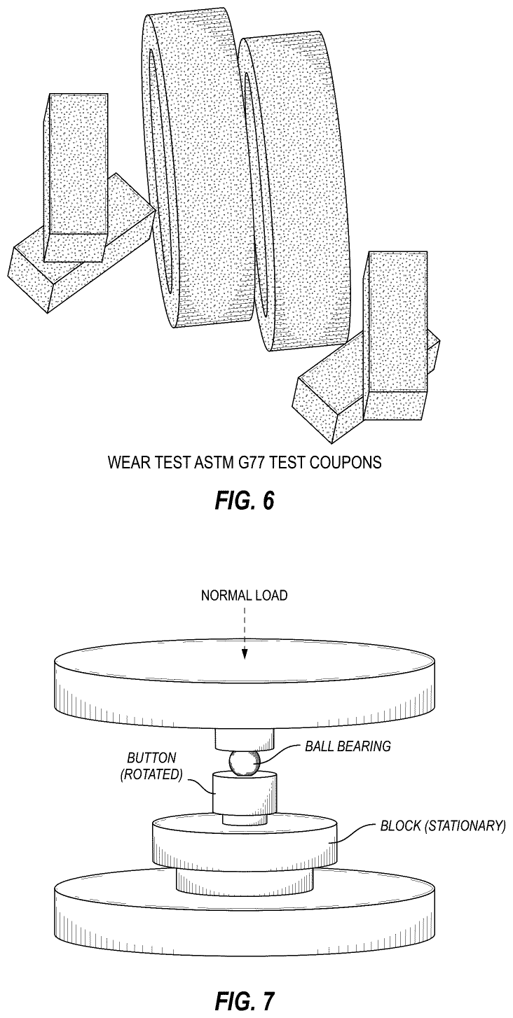

FIG. 6 is a picture of the sample before testing with coated 4140-steel on the left hand side and coated Inconel 718 alloy on the right hand side. Between about 20,000 pounds to about 30,000 pounds are applied vertically to the sample while it rotates up to 270°.

FIG. 7 shows a schematic of the galling test set-up following the ASTM G98 standard of testing.

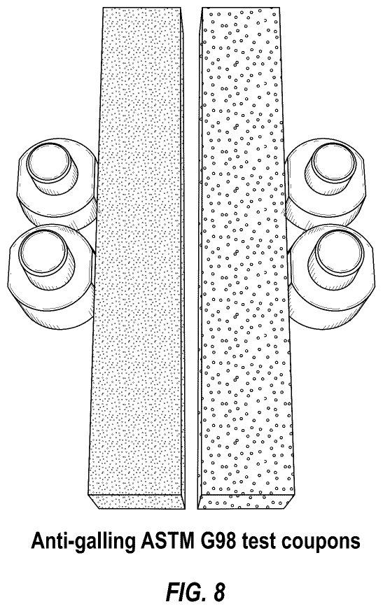

FIG. 8 is a picture of the test coupons before the ASTM G98 standard of testing for the aromatic thermosetting copolyester (ATSP) coating deposited on 4140 steel on the left hand side (darker color) and deposited on the Inconel 718 on the right-hand side.

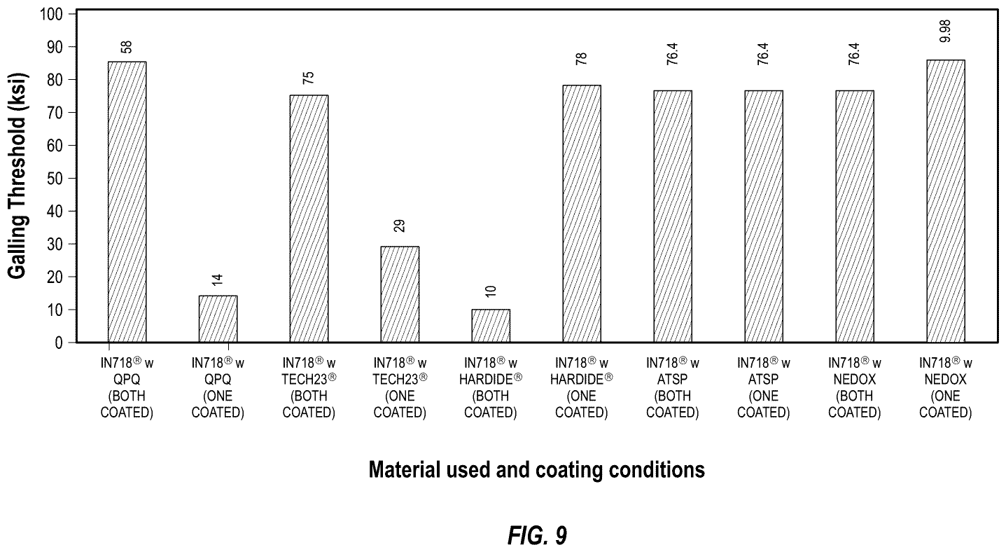

The results of the anti-galling testing of aromatic thermosetting copolyester (ATSP) coatings and other coatings on Inconel 718 following the ASTM G98 standard of testing are shown in FIG. 9. Aromatic thermosetting copolyester coating shows excellent galling threshold. The galling threshold is independent of whether one of the target metals or the upper button is coated unlike the other coatings. The results are highly dependent on the configuration of coatings: the galling threshold is much lower when both surfaces are coated as compared to only one surface coated.

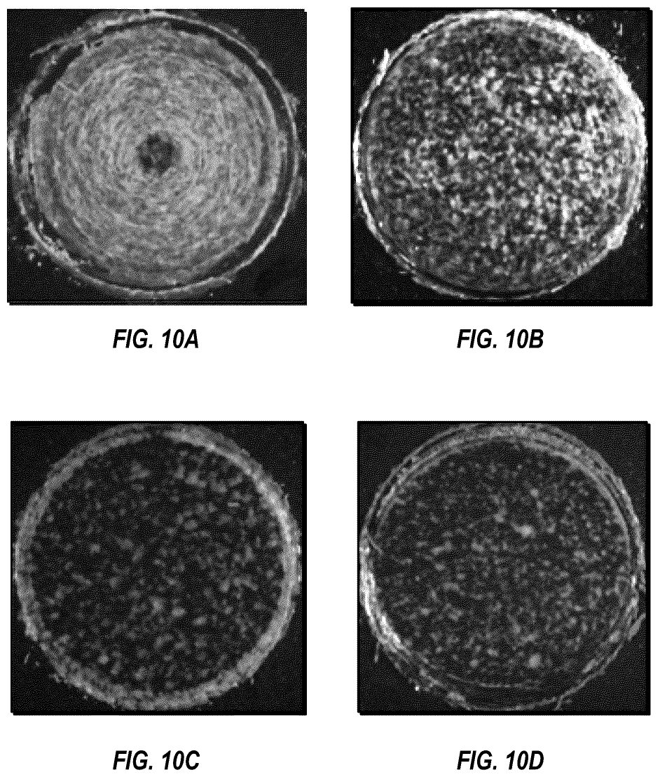

FIG. 10A shows the picture of the anti-galling test result with the upper buttons being 4140 steel coated with the aromatic thermosetting copolyester (ATSP) while the lower target is 4140 steel coated with the aromatic thermosetting copolyester (ATSP).

FIG. 10B shows the picture of the anti-galling test result with the upper buttons being 4140 steel without any coating while the lower target being 4140 steel coated with the aromatic thermosetting copolyester (ATSP).

FIG. 10C shows the picture of the anti-galling test result with the upper buttons being 718 alloy coated with the aromatic thermosetting copolyester (ATSP) while the lower target is 718 alloy coated with the aromatic thermosetting copolyester (ATSP).

FIG. 10D shows the picture of the anti-galling test result with the upper buttons being 718 alloy without any coating while the lower target is 718 alloy coated with the aromatic thermosetting copolyester (ATSP).

In these figures, it can be observed that the coating still adheres to the samples after the anti-galling tests showing the formation of the transfer layer of the coatings on the 4140-steel substrate for FIG. 10A and on the Inconel 718 alloy substrate in FIG. 10C.

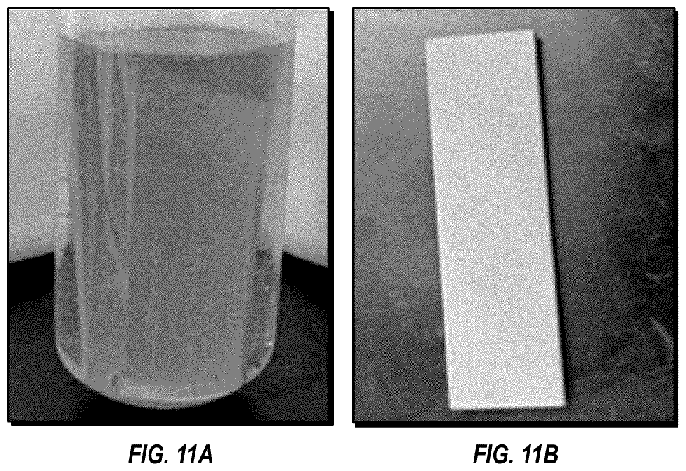

A chemical resistance test was performed on a 4140-steel coated with the aromatic thermosetting copolyester (ATSP) is shown in FIG. 11A-B.

FIG. 11A is a picture of a coupon of the 4140-steel coated with the aromatic thermosetting copolyester (ATSP) immersed in a solution containing 15% by weight hydrochloric acid for seven days at a temperature of 350 F.

FIG. 11B is a picture of the coupon of the 4140-steel coated with the aromatic thermosetting copolyester (ATSP) after the immersion test. The aromatic thermosetting copolyester (ATSP) coating shows no signs of flaking after the immersion test. The coating shows no effect while immersed in reagent grade nitric acid, copper sulphate pentahydrate, or potassium ferricyanide solutions either (pictures not shown). The copper sulfate solution was made up of 16 grams of copper sulfate pentahydrate (>98% ACS Reagent Grade), 4 ml of sulfuric acid (95%-98% ACS Reagent Grade) completed to 1000 ml with deionized water. The potassium ferricyanide solution was made up of 25 grams of potassium ferricyanide, 15 grams of sodium chloride (NaCl) completed to 1000 ml with deionized water.

For the sake of brevity, only certain ranges are explicitly disclosed herein. However, ranges from any lower limit may be combined with any upper limit to recite a range not explicitly recited, as well as, ranges from any lower limit may be combined with any other lower limit to recite a range not explicitly recited, in the same way, ranges from any upper limit may be combined with any other upper limit to recite a range not explicitly recited. Additionally, whenever a numerical range with a lower limit and an upper limit is disclosed, any number and any included range falling within the range are specifically disclosed. In particular, every range of values (of the form, “from about a to about b,” or, equivalently, “from approximately a to b,” or, equivalently, “from approximately a-b”) disclosed herein is to be understood to set forth every number and range encompassed within the broader range of values even if not explicitly recited. Thus, every point or individual value may serve as its own lower or upper limit combined with any other point or individual value or any other lower or upper limit, to recite a range not explicitly recited.

Therefore, the present embodiments are well adapted to attain the ends and advantages mentioned as well as those that are inherent therein. The particular embodiments disclosed above are illustrative only, as the present embodiments may be modified and practiced in different but equivalent manners apparent to those skilled in the art having the benefit of the teachings herein. Although individual embodiments are discussed, all combinations of each embodiment are contemplated and covered by the disclosure. Furthermore, no limitations are intended to the details of construction or design herein shown, other than as described in the claims below. Also, the terms in the claims have their plain, ordinary meaning unless otherwise explicitly and clearly defined by the patentee. It is therefore evident that the particular illustrative embodiments disclosed above may be altered or modified and all such variations are considered within the scope and spirit of the present disclosure.

1. A system comprising a substrate for downhole applications coated with an aromatic thermosetting copolyester mixed with polytetrafluoroethylene (PTFE).

2. The system of claim 1, wherein the coating comprises from about 0.1 wt % to about 30 wt % of PTFE.

3. The system of claim 1, wherein the coating comprises from about 0.1 wt % to about 10 wt % PTFE.

4. The system of claim 1, wherein the coating comprises from about 0.1 wt % to about 3 wt % PTFE.

5. The system of claim 1, wherein a thickness of the coating is in between about 50 μm and about 200 μm.

6. The system of claim 1, wherein a thickness of the coating is less than about 8 μm.

7. The system of claim 1, wherein a thickness of the coating is less than about 5 μm.

8. The system of claim 1, wherein the substrate is metallic.

9. The system of claim 1, wherein the substrate is non-metallic.

10. The system of claim 1, wherein the coating further comprises at least one additive selected from the group of additives consisting of polyimide (PI), graphite, mullite, molybdenum disulfide (MoS₂), diamond, boron, copper, carbon, carbon black, graphene nanotubes, mica, carbon nanotubes (CNTs), polyether ether ketone (PEEK), polyether ketone ketone (PEKK), polyphthalamide (PPA), and any combination thereof.

11. The system of claim 1, wherein the substrate is a metallic substrate selected from the group of metallic substrates consisting of high-strength low-alloy steels, martensitic stainless steels, supermartensitic stainless steels, duplex stainless steels, super duplex stainless steels, austenitic stainless steels, alloys in the nickel-chromium-molybdenum (Ni—Cr—Mo) family, solution-strengthened nickel-based alloys, precipitation-hardening nickel-based alloys, magnesium-based alloys, and any combination thereof.

12. The system of claim 1, wherein the substrate is a non-metallic substrate selected from the group of non-metallic substrates consisting of polyether ether ketone (PEEK), polyether ketone ketone (PEKK), polyphthalamide (PPA), polyetherimide (PEI), polyphenylene sulfide (PPS), polytetrafluoroethylene (PTFE), polyamide (PA), epoxy, phenolic, bis-maleimide (BMI), elastomers, and any combination thereof.

13. The system of claim 1, wherein the substrate for downhole applications comprises at least one substrate selected from the group consisting of sub surface safety valves, barrier valves, mandrels, flow tubes, sleeves, threads, splined cylinders, drill bits, components of sand control screen assembly, seal assemblies, and any combination thereof.

14. A system comprising a substrate for downhole applications coated with an aromatic thermosetting copolyester mixed with from about 0.1 wt % to about 10 wt % polytetrafluoroethylene (PTFE), wherein the substrate for downhole applications comprises at least one substrate selected from the group consisting of sub surface safety valves, barrier valves, mandrels, flow tubes, sleeves, threads, splined cylinders, drill bits, components of sand control screen assembly, seal assemblies, and any combination thereof.

15. The system of claim 14, wherein the coating further comprises at least one additive selected from the group of additives consisting of polyimide (PI), graphite, mullite, MoS₂, diamond, boron, copper, carbon, carbon black, graphene nanotubes, mica, carbon nanotubes (CNTs), polyether ether ketone (PEEK), polyether ketone ketone (PEKK), polyphthalamide (PPA), and any combination thereof.

16. The system of claim 14, wherein a thickness of the coating is in between about 50 μm and about 200 μm.

17. The system of claim 14, wherein a thickness of the coating is less than about 5 μm.

18. A system comprising a substrate for downhole applications coated with an aromatic thermosetting copolyester mixed with from about 0.1 wt % to about 10 wt % polytetrafluoroethylene (PTFE), wherein the substrate is a metallic substrate selected from the group of metallic substrates consisting of high-strength low-alloy steels, martensitic stainless steels, supermartensitic stainless steels, duplex stainless steels, super duplex stainless steels, austenitic stainless steels, alloys in the nickel-chromium-molybdenum (Ni—Cr—Mo) family, solution-strengthened nickel-based alloys, precipitation-hardening nickel-based alloys, magnesium-based alloys, and any combination thereof.

19. The system of claim 18, wherein the coating further comprises at least one additive selected from the group of additives consisting of polyimide (PI), graphite, mullite, MoS₂, diamond, boron, copper, carbon, carbon black, graphene nanotubes, mica, carbon nanotubes (CNTs), polyether ether ketone (PEEK), polyether ketone ketone (PEKK), polyphthalamide (PPA), and any combination thereof.

20. The system of claim 18, wherein a thickness of the coating is in between about 50 μm and about 200 μm.
